(19) United States
(12) Patent Application Publication
(10) Pub. No.: US 2024/0380707 A1
(43) Pub. Date: Nov. 14, 2024

(54) ARITHMETIC PROCESSING OFFLOAD SYSTEM AND ARITHMETIC PROCESSING OFFLOAD METHOD

(71) Applicant: Nippon Telegraph and Telephone Corporation, Tokyo (JP)

(72) Inventors: Shogo SAITO, Musashino-shi, Tokyo (JP); Kei FUJIMOTO, Musashino-shi, Tokyo (JP)

(21) Appl. No.: 18/691,078

(22) PCT Filed: Oct. 1, 2021
(86) PCT No.: PCT/JP2021/036491

§ 371 Date: Mar. 12, 2024

(51) Int. Cl. H04L 47/43

(52) U.S. Cl. CPC H04L 47/43

(57) ABSTRACT

An NIC hardware includes an accelerator function and argument data parsing unit that deserializes packet data input from a client side according to a predetermined protocol format and obtains a function name and multiple arguments; an accelerator function and return value data packetization unit that serializes a function name and arguments input from an accelerator according to a predetermined protocol format and packetizes the function name and arguments as a payload; and a data transfer unit that transfers data from the accelerator function and argument data parsing unit to a server.

### TECHNICAL FIELD

The present invention relates to a computation offloading system and a computation offloading method.

### BACKGROUND ART

With the progress of cloud computing, it has become widespread to simplify the configuration of a client machine by offloading processing with a large amount of computation from a client machine deployed in a user site to a server at a remote site (such as a datacenter located near the user) via a network (hereafter referred to as NW) (see NPL 1).

FIG. 15 is a diagram illustrating a device configuration of an offloading system via an NW.

As illustrated in FIG. 15, the offloading system via an NW1 includes a client 10 deployed at a user site and a server 50 connected to the client 10 via the NW1.

The client 10 is a terminal which is driven by a battery or the like and has a limited computing power.

The client 10 includes a client HW (hardware) 20, an OS (Operating System) 30, and an application (hereinafter referred to as APL as appropriate) 40.

The APL 40 includes a client application unit 41, an ACC utilization IF 42, and middleware 43. The ACC utilization IF 42 is an ACC (Accelerator: calculation accelerator device) utilization IF specification composed of OpenCL (Open Computing Language) or the like.

The client 10 does not include a calculation accelerator device (hereinafter referred to as ACC) such as FPGA (Field Programmable Gate Array) and GPU (Graphics Processing Unit). The client 10 has an NIC (Network Interface Card) 21 mounted on the client HW 20.

The client application unit 41 is a program executed in the user space. The offloading system via the NW is constructed on the assumption of using specified APIs (Application Programming Interfaces) such as OpenCL, and performs input/output with respect to these APIs.

The client application unit 41 is an application that operates on the client 10 and complies with a standard API (Application Programming Interface) for ACC access. The client application unit 41 that operates on the client 10 requires low computational latency because it is assumed that image processing and the like is performed.

The server 50 includes a server HW 60, an OS 70, an APL 80, and an accelerator (ACC) 62 on the server HW 60. The APL 80 has offload middleware 81.

The server 50 is equipped with one or more accelerators 62.

The server 50 has an NIC 61 mounted on the server HW 60.

The client 10 and the server 50 can communicate with each other through their respective NICs 21 and 61 and the NW1.

The offloading system illustrated in FIG. 15 preferably satisfies requirements 1 to 3 below.

Requirement 1: No change is added to the client application unit 41 (transparency).

Requirement 2: The client-side terminal (the client 10) does not require special hardware such as NIC (versatility).

Requirement 3: ACC computation offload via an NW1 must be in a low overhead state (low latency).

As a conventional technology for transparent accelerator processing offloading via an NW, “remote offloading by packetization of function name and arguments of accelerator standard IF functions and NW transfer” (see NPL 1) is known.

FIG. 16 is a diagram illustrating an accelerator standard IF offloading system using the OS protocol stack described in NPL 1. In the description of FIG. 16, the same components as those in FIG. 15 are denoted by the same reference signs.

The solid-line arrow in FIG. 16 indicates the offload forward path, and the dashed-line arrow in FIG. 16 indicates the offload backward path.

As illustrated in FIG. 16, the accelerator standard IF offloading system includes a client 10 and a server 50 connected to the client 10 via an NW1.

The client 10 illustrated in FIG. 16 includes a client HW 20, an OS 30, and an application (hereinafter referred to as APL as appropriate) 40. In addition, the NIC 21 is provided on the client HW 20.

The OS 30 has an L4/L3 protocol stack unit 31 and an NIC driver unit 32.

The APL 40 has a client application unit 41, an ACC function proxy reception unit 44, an ACC function and return value packetization unit 45, an ACC function and argument data parsing unit 46, and an ACC function proxy response unit 47.

The server 50 illustrated in FIG. 16 includes a server HW 60, an OS 70, an APL 80, an NIC 61 on the server HW 60, and an accelerator 62.

The OS 70 has an L4/L3 protocol stack unit 71 and a NIC driver unit 72.

The APL 80 has an ACC function and argument data parsing unit 82, an ACC function proxy execution unit 83, and an ACC function and return value packetization unit 84.

Next, the offload forward path and the offload backward path will be described.

### Offload Forward Path

The client application unit 41 of the client 10 has input/output with respect to a specified API such as OpenCL. The ACC function proxy reception unit 44 is implemented as middleware having an IF compatible with a specified API. The ACC function proxy reception unit 44 has an IF equivalent to a specified API such as OpenCL, and receives API calls from the client application unit 41. The ACC function proxy reception unit 44 receives function name and arguments from the client application unit 41 as an input (see symbol a in FIG. 16). The ACC function proxy reception unit 44 passes the function name and arguments to the ACC function and return value packetization unit 45 as an output (see symbol b in FIG. 16).

The ACC function and return value packetization unit 45 passes a transmission packet to the L4/L3 protocol stack unit 31 based on the received function name and argument (see symbol c in FIG. 16).

The L4/L3 protocol stack unit 31 makes the input packet conform to the L4/L3 protocol, and the NIC driver unit 32 passes the transmission packet conforming to the L4/L3 protocol to the NIC 21 (see symbol d in FIG. 16).

The NIC 21 transmits the packet to the NIC 61 of the server 50 connected via the NW1.

The NIC driver unit 72 of the server 50 receives the packet from the NIC 61 (see symbol e in FIG. 16) and passes it to the L4/L3 protocol stack unit 71. The L4/L3 protocol stack unit 71 converts the reception packet according to the L4/L3 protocol into processable packet data and passes it to the ACC function and argument data parsing unit 82 (see symbol f in FIG. 16).

The ACC function and argument data parsing unit 82 deserializes the packet data and passes the function name and execution result to the ACC function proxy execution unit 83 (see symbol g in FIG. 16).

The ACC function proxy execution unit 83 offloads the accelerator function and argument data based on the received function name and execution result to the accelerator (ACC) 62 (see symbol h in FIG. 16) for execution.

### Offload Backward Path

The accelerator 62 executes the ACC function, and passes the function name and function execution result to the ACC function proxy execution unit 83 (see symbol i in FIG. 16). The ACC function proxy execution unit 83 passes the function name and function execution result from the accelerator 62 to the ACC function and return value packetization unit 84 (see symbol j in FIG. 16).

The ACC function and return value packetization unit 84 packetizes the passed function name and function execution result, and passes the packets to the L4/L3 protocol stack unit 71 (see symbol k in FIG. 16).

The L4/L3 protocol stack unit 71 makes the packet data conform to the L4/L3 protocol, and the NIC driver unit 72 passes the packet data conforming to the L4/L3 protocol to the NIC 61 (see symbol 1 in FIG. 16).

The NIC 61 transmits the packet to the NIC 21 of the client 10 connected via the NW1.

The NIC driver unit 32 of the client 10 receives the packet from the NIC 21 (see symbol m in FIG. 16) and passes it to the L4/L3 protocol stack unit 31. The L4/L3 protocol stack unit 31 converts the reception packet conforming to the L4/L3 protocol into processable packet data and passes it to the ACC function and argument data parsing unit 46 (see symbol n in FIG. 16). The ACC function and argument data parsing unit 46 deserializes the function name and execution result into serial data, and passes it to the ACC function proxy response unit 47 (see symbol o in FIG. 16).

The ACC function proxy response unit 47 passes the received serial data to the client application unit 41 as accelerator processing data (see symbol p in FIG. 16).

In the above configuration, both the client 10 and the server 50 use dedicated NICs (for example, RDMA HCA: Remote Direct Memory Access Host Channel Adapter) with protocol stack processing functions. Both the client 10 and the server 50 have protocol stack functional units in the OSs 30 and 70.

### CITATION LIST

### Non Patent Literature

[NPL 1] “rCUDA v20.07alpha User's Guide,” The rCUDA Team, July 2020, [online], [retrieved on Aug. 4, 2021], Internet <URL: http://www.rcuda.net/pub/rCUDA_guide.pdf>

### SUMMARY OF INVENTION

### Technical Problem

However, in the offloading system described in NPL 1, as illustrated in FIG. 16, the L4/L3 protocol stack unit 31 of the OS 30, the ACC function and argument data parsing unit 46, and the ACC function and return value packetization unit 45 are independent. Similarly, the L4/L3 protocol stack unit 71 of the OS 70, the ACC function and argument data parsing unit 82, and the ACC function and return value packetization unit 84 are independent. For this reason, overhead occurs in linkage between the L4/L3 protocol stack function of the OS and the ACC function and argument data (hereafter, linkage refers to the ability to parse, generate packets, and execute processing), making it difficult to reduce latency.

The present invention has been made in view of such a background, and an object of the present invention is to reduce the latency by eliminating the overhead in the linkage between the “protocol stack” of the OS and the “ACC function and argument data”.

### Solution to Problem

In order to solve the above-described problems, the present invention provides a computation offloading system which includes a client and a server connected to the client via a network and an NIC functional unit, and in which the client offloads specific processing of an application to an accelerator disposed in the server to perform computation, wherein the NIC functional unit includes: an accelerator function and argument data parsing unit that deserializes packet data input from the client side according to a predetermined protocol format and obtains a function name and multiple arguments; an accelerator function and return value data packetization unit that serializes a function name and arguments input from the accelerator according to a predetermined protocol format and packetizes the function name and arguments as a payload; and a data transfer unit that transfers the data deserialized by the accelerator function and argument data parsing unit to the server.

### Advantageous Effects of Invention

According to the present invention, it is possible to reduce the latency by eliminating the overhead in the linkage between the “protocol stack” of the OS and the “ACC function and argument data”.

### BRIEF DESCRIPTION OF DRAWINGS

FIG. 1 is a schematic configuration diagram of a computation offloading system according to an embodiment of the present invention.

FIG. 2 is a diagram illustrating an offloading processing flow of the computation offloading system according to the embodiment of the present invention.

FIG. 3 is a diagram illustrating a configuration example of an ACC function and argument data packet of the computation offloading system according to the embodiment of the present invention.

FIG. 4 is a diagram illustrating a configuration example of an accelerator function and return value packet of the computation offloading system according to the embodiment of the present invention.

FIG. 5 is a functional block diagram of NIC hardware of the computation offloading system according to the embodiment of the present invention.

FIG. 6 is a diagram illustrating an outline of middleware processing in a reception unit of a client of the conventional technology.

FIG. 7 is a diagram illustrating an outline of NIC hardware processing of the computation offloading system according to the embodiment of the present invention.

FIG. 8 is a control sequence illustrating offloading processing of the computation offloading system according to the embodiment of the present invention.

FIG. 9 is a flowchart illustrating offloading processing when the client of the computation offloading system according to the embodiment of the present invention performs transmission.

FIG. 10 is a flowchart illustrating offloading processing of the NIC hardware server of the computation offloading system according to the embodiment of the present invention.

FIG. 11 is a flowchart illustrating offloading processing when the client of the computation offloading system according to the embodiment of the present invention performs reception.

FIG. 12 is a schematic configuration diagram of a computation offloading system according to <Modification 1> of the embodiment of the present invention.

FIG. 13 is a schematic configuration diagram of a computation offloading system according to <Modification 2> of the embodiment of the present invention.

FIG. 14 is a hardware configuration diagram illustrating an example of a computer that implements the functions of the client of the computation offloading system according to the embodiment of the present invention.

FIG. 15 is a diagram illustrating the device configuration of an offloading system via an NW.

FIG. 16 is a diagram illustrating an accelerator standard IF offloading system using an OS protocol stack described in NPL 1.

### DESCRIPTION OF EMBODIMENTS

Hereinafter, a computation offloading system and the like according to a mode for carrying out the present invention (hereinafter referred to as “the present embodiment”) will be described with reference to the drawings.

### EMBODIMENTS

### [Outline]

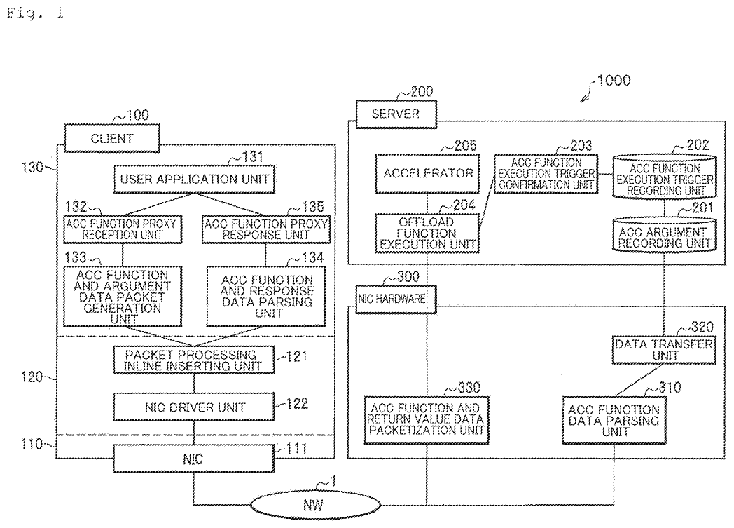

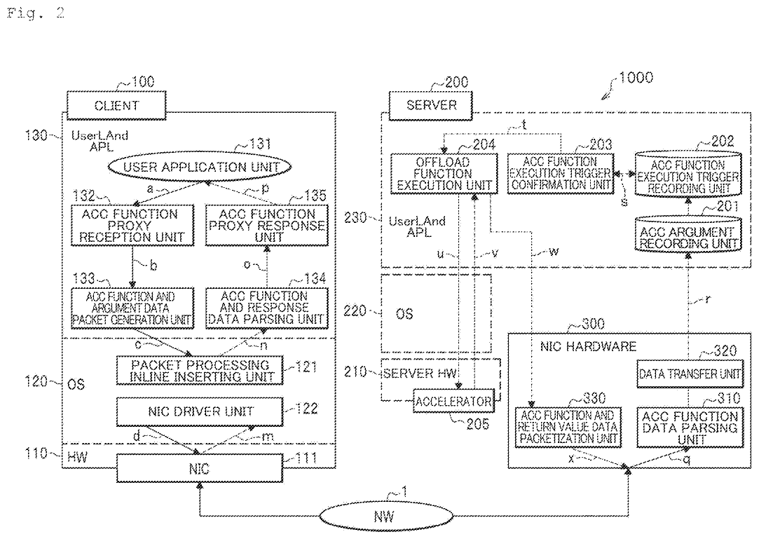

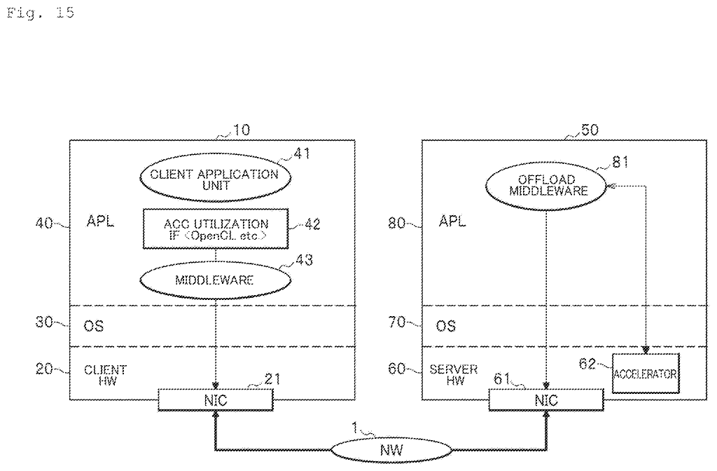

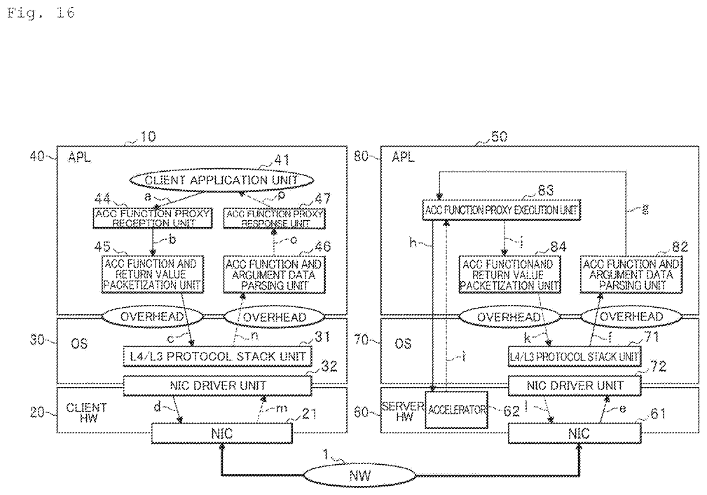

FIG. 1 is a schematic configuration diagram of a computation offloading system according to an embodiment of the present invention. The present embodiment is an example applied to offloading processing using XDP (express Data Path)/eBPF (Berkeley Packet Filter) of Linux (registered trademark). FIG. 2 is a diagram illustrating the offloading processing flow of a computation offloading system 1000 of FIG. 1. The same components as those in FIGS. 15 and 16 are denoted by the same reference signs. Note that the offloading processing flow of FIG. 2 will be described in detail in the description of operations.

As illustrated in FIGS. 1 and 2, the computation offloading system 1000 includes a client 100, a server 200 connected to the client 100 via an NW1 and an NIC hardware 300, and the NIC hardware 300 (NIC functional unit), which is an NIC functional unit provided on the server 200 side.

In particular, the computation offloading system 1000 is characterized in that it has the NIC hardware 300 as a server-side NIC.

In the computation offloading system 1000, the client 100 offloads specific processing of an application to an accelerator 205 disposed in the server 200 and performs computation.

### [Client 100]

The client 100 includes a client HW 110, an OS 120 and a UserLAnd APL 130.

### <<Client HW 110>>

The client HW 110 has an NIC 111.

The NIC 111 is NIC hardware that implements an NW interface.

In the <transmission pattern>, the NIC 111 receives a “transmission packet” from the packet processing inline inserting unit 121 via the NIC driver unit 122 as an input. In the <transmission pattern>, the NIC 111 passes the “transmission packet” to the NIC hardware 300 connected via the NW1 as an output.

In the <reception pattern>, the NIC 111 receives a “reception packet” from the server 200 connected via the NIC hardware 300 and the NW1 as an input. In the <reception pattern>, the NIC 111 passes the “reception packet” to the packet processing inline inserting unit 121 via the NIC driver unit 122 as an output.

### <<OS120>>

The OS 120 has a packet processing inline inserting unit 121 and an NIC driver unit 122.

### <Packet Processing Inline Inserting Unit 121>

The packet processing inline inserting unit 121 is a transmission/reception function that exchanges input packet data (“transmission packet”) with a device driver (the NIC driver unit 122) without using an existing protocol stack. The packet processing inline inserting unit 121 corresponds to, for example, a high-speed communication mechanism with a driver such as XDP/eBPF of Linux (registered trademark).

The packet processing inline inserting unit 121 exchanges data without using a predetermined protocol stack between the ACC function and argument data packet generation unit 133 and the ACC function and response data parsing unit 134 of the UserLAnd APL 130 and the NIC driver unit 122 that collects data from the NIC 111.

In the <transmission pattern>, the packet processing inline inserting unit 121 receives a “transmission packet” from the ACC function and argument data packet generation unit 133 of the UserLAnd APL 130 as an input. In the <transmission pattern>, the packet processing inline inserting unit 121 passes the “transmission packet” to the NIC driver unit 122 as an output.

In the <reception pattern>, the packet processing inline inserting unit 121 receives a “reception packet” from the NIC driver unit 122 as an input. In the <reception pattern>, the packet processing inline inserting unit 121 passes the “reception packet” to the ACC function and response data parsing unit 134 as an output.

### <NIC Driver Unit 122>

The NIC driver unit 122 is a device driver that abstracts an interface unique to each NIC type. The NIC driver unit 122 is composed of a normal commercial device driver.

In the <transmission pattern>, the NIC driver unit 122 receives a “transmission packet” from the packet processing inline inserting unit 121 as an input. In the <transmission pattern>, the NIC driver unit 122 passes the “transmission packet” to the NIC 111 as an output.

In the <reception pattern>, the NIC driver unit 122 receives a “reception packet” from the NIC 111 as an input. In the <reception pattern>, the NIC driver unit 122 passes the “reception packet” to the packet processing inline inserting unit 121 as an output.

### <<UserLAnd APL130>>

The UserLAnd APL 130 includes a user application unit 131, an ACC function proxy reception unit 132, an L3/L4 protocol and ACC function and argument data packet generation unit (hereinafter referred to as an ACC function and argument data packet generation unit) 133, an L3/L4 protocol and ACC function and response data parsing unit (hereinafter referred to as an ACC function and response data parsing unit) 134, and an ACC function proxy response unit 135.

### <User Application Unit 131>

The user application unit 131 is a program executed in the user space. The user application unit 131 is constructed on the premise of using specified APIs such as OpenCL, and performs input/output with respect to these APIs. The user application unit 131 has “function name and arguments” for the ACC function proxy reception unit 132 as an output. The user application unit 131 receives function execution results from the ACC function proxy response unit 135 as an input.

The user application unit 131 may have a result output destination such as image drawing on a display as another output destination.

### <ACC Function Proxy Reception Unit 132>

The ACC function proxy reception unit 132 is implemented as middleware having an IF compatible with a specified API. The ACC function proxy reception unit 132 has an IF equivalent to a specified API such as OpenCL, and receives API calls from users. The ACC function proxy reception unit 132 is prepared as a binary file separate from a specified user application, and is implemented in a “dynamic library format” in which dynamic linking and calling are performed during execution. The ACC function proxy reception unit 132 receives “function name and arguments” from the user application unit 131 as an input. The ACC function proxy reception unit 132 passes the “function name and arguments” to the ACC function and argument data packet generation unit 133 as an output.

The ACC function proxy reception unit 132 may be in a “static library format” in which it is linked to the user application when the program is generated and executed integrally.

### <Outline of ACC Function and Argument Data Packet Generation Unit 133 and ACC Function and Response Data Parsing Unit 134>

Here, an outline of the ACC function and argument data packet generation unit 133 and the ACC function and response data parsing unit 134 will be briefly described first (detailed description will be provided later).

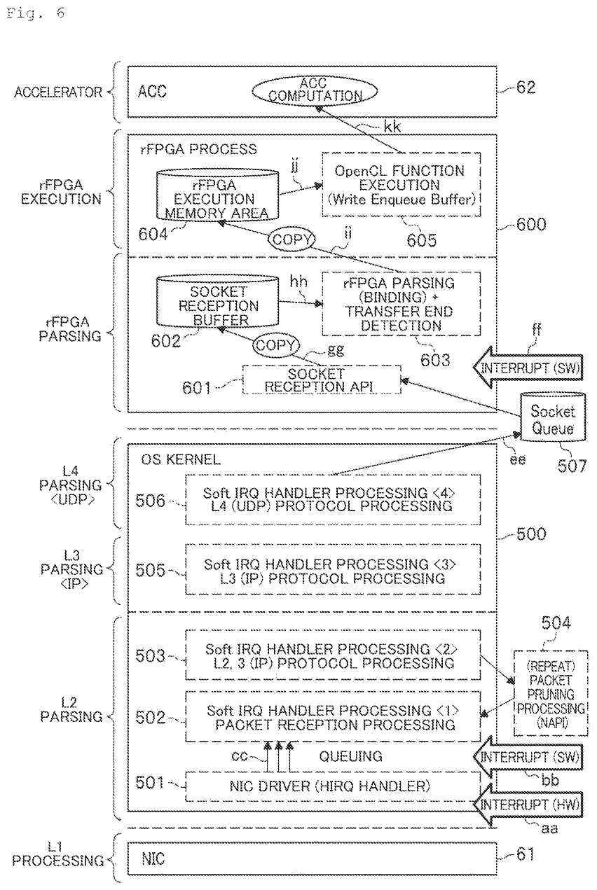

(1) The ACC function and argument data packet generation unit 133 is characterized in that it is a single dedicated function in which the ACC function and return value packetization unit 45 on the APL 40 side and the L4/L3 protocol stack unit 31 of the OS 30 in the accelerator standard IF offloading system of the conventional technology illustrated in FIG. 16 are combined. A single dedicated function is one in which as described in the conventional technology illustrated in FIG. 6 below, protocol processing functions such as Soft IRQ handler processing and L2, L3 protocol processing of an OS kernel 500 shown in FIG. 6, packet pruning processing (NAPI), Soft IRQ handler processing and L4 protocol processing, and ACC function parsing processing are integrated into a single function. In the conventional technology, there are multiple protocol processing functions, but in the present embodiment, the ACC function and argument data packet generation unit 133 is integrated into a single dedicated function.

Similarly to the ACC function and argument data packet generation unit 133, the ACC function and response data parsing unit 134 is characterized in that it is a single dedicated function in which the function and argument data parsing unit 46 on the APL 40 side and the L4/L3 protocol stack unit 31 of the OS 30 in the accelerator standard IF offloading system of the conventional technology illustrated in FIG. 16 are combined.

In this way, in the conventional technology, there are multiple protocol processes (L2, L3 protocol processing, packet pruning processing (NAPI), L4 protocol processing, ACC function parsing processing, and the like), and processing for selecting a protocol stack such as L4/L3 was necessary. In contrast, the computation offloading system 1000 is characterized in that it is a dedicated one eliminating multiple protocol processing required in the conventional technology by including the ACC function and argument data packet generation unit 133 and the ACC function and response data parsing unit 134 having a single dedicated function. As a result, the computation offloading system 1000 can reduce overhead and increase the processing speed by reducing the number of times of selection and copy with the linkage of data on the client 100 side.

### <ACC Function and Argument Data Packet Generation Unit 133>

The ACC function and argument data packet generation unit 133 converts the input function name and arguments into data as UDP/IP packets and their payloads.

The ACC function and argument data packet generation unit 133 serializes the function name and arguments input from the application side according to a predetermined protocol format, and packetizes it as a payload to convert it into a single piece of data.

The ACC function and argument data packet generation unit 133 receives the “function name and arguments” from the ACC function proxy reception unit 132 as an input. The ACC function and argument data packet generation unit 133 passes the “transmission packet” to the packet processing inline inserting unit 121 as an output.

Here, the L3/L4 protocol may be TCP/IP (Transmission Control Protocol/Internet Protocol) or a protocol other than TCP/IP, such as one which eliminates a part of L3/L4 and uses only L3. The packet format may include not only the function name and arguments, but also an ID that uniquely identifies the accelerator to be used.

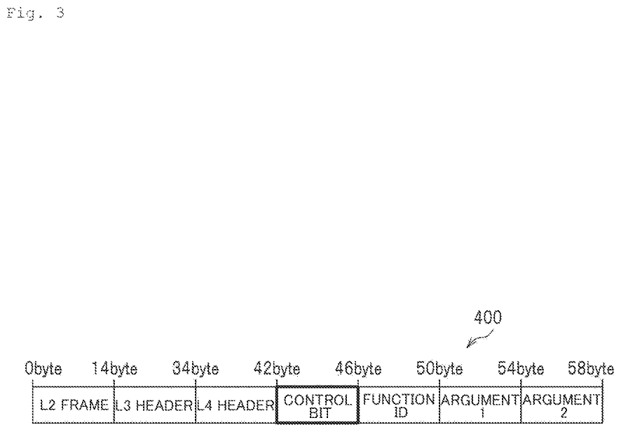

Also, if the argument size is large, a function of dividing a packet into multiple packets may be provided. In this case, control data for notifying the final packet illustrated in FIG. 3 is added to the last divided packet.

### <ACC Function and Response Data Parsing Unit 134>

The ACC function and response data parsing unit 134 deserializes the packet data input from the server 200 side according to a predetermined protocol format, and acquires the function name and execution result.

The ACC function and response data parsing unit 134 acquires the “function name and execution result” from the input data by deserializing the input packet data, and passes it to the ACC function proxy response unit 135.

The ACC function and response data parsing unit 134 receives the “reception packet” from the packet processing inline inserting unit 121 as an input. The ACC function and response data parsing unit 134 passes the “function name and execution result” to the ACC function proxy response unit 135 as an output.

An embodiment of the packet format of the ACC function and response data parsing unit 134 conforms to the ACC function data parsing unit 310 described later. Further, when the ACC function and response data parsing unit 134 has a function of dividing a packet into multiple packets, the ACC function data parsing unit 310, which will be described later, also has a binding function.

### <ACC Function Proxy Response Unit 135>

The ACC function proxy response unit 135 is implemented as middleware having an IF compatible with a specified API. The ACC function proxy response unit 135 is prepared as a binary file separate from the user application unit 131, and is implemented in a “dynamic library format” in which dynamic linking and calling are performed during execution.

The ACC function proxy response unit 135 exchanges data without using a predetermined protocol stack between the ACC function data parsing unit 310 and the ACC function and return value data packetization unit 330, and the NIC driver unit 122 that collects data from the NIC 111.

The ACC function proxy response unit 135 receives the “function name and execution result” from ACC function and response data parsing unit 134 as an input. The ACC function proxy response unit 135 passes a “return value” (response data) to the user application unit 131 as an output.

The ACC function proxy response unit 135 may be in a “static library format” in which it is linked to the user application when the program is generated and executed integrally.

### [Server 200]

As illustrated in FIG. 2, the server 200 includes a server HW 210, an OS 220, and a UserLAnd APL 230.

### <<Server HW 210>>

As illustrated in FIG. 2, the server HW 210 includes an accelerator 205 (see also FIG. 1).

### <Accelerator 205>

The accelerator 205 is computing unit hardware that performs specific computation at a high speed based on inputs from the CPU. The accelerator 205 corresponds to the GPU/FPGA connected to the server 200.

In the <transmission pattern>, the accelerator 205 receives “ACC instruction data” from a data transfer unit 320 as an input. In the <transmission pattern>, the accelerator 205 passes the “execution result” to the data transfer unit 320 via each functional unit as an output.

The accelerator 205 may be one such as a System on Chip (SoC) in which a CPU and an accelerator are integrated as one chip. If the accelerator 205 is not mounted, an offload function execution unit 204 may not be present.

### <<UserLAnd APL 230>>

As illustrated in FIG. 2, the UserLAnd APL 230 includes an ACC argument recording unit 201, an ACC function execution trigger recording unit 202, an ACC function execution trigger confirmation unit 203, and an offload function execution unit 204 (see also FIG. 1).

### <ACC Argument Recording Unit 201>

The ACC argument recording unit 201 records information on input function name and arguments. The ACC argument recording unit 201 receives and records the “transfer target data” from the data transfer unit 320 as an input.

### <ACC Function Execution Trigger Recording Unit 202>

The ACC function execution trigger recording unit 202 records whether the arguments recorded in the ACC argument recording unit 201 are complete and the ACC function is executable. The ACC function execution trigger recording unit 202 receives an executable trigger from the data transfer unit 320 as an input, and the data transfer unit 320 updates the state.

### <ACC Function Execution Trigger Confirmation Unit 203>

The ACC function execution trigger confirmation unit 203 refers to the ACC function execution trigger recording unit 202, and detects that the offload function execution unit 204 can execute the ACC function based on the data recorded in the ACC argument recording unit 201.

The ACC function execution trigger confirmation unit 203 constantly monitors the ACC function execution trigger recording unit 202 as an input and confirms whether it is in an executable state. This confirmation method may be either a polling mode in which the ACC function execution trigger confirmation unit 203 actively and repeatedly obtains and confirms the state, or an interrupt mode in which a notification is received when a change occurs.

### <Offload Function Execution Unit 204>

The offload function execution unit 204 executes the accelerator function based on the input function name and arguments, and links the result to the accelerator 205. As an embodiment, the OpenCL runtime which is an existing accelerator-using runtime and the CUDA runtime are assumed.

In the <execution pattern>, the offload function execution unit 204 receives “function name and arguments” from the ACC argument recording unit 201 as an input. In the <execution pattern>, the offload function execution unit 204 passes “ACC instruction data” to the accelerator 205 as an output.

In the <result response pattern>, the offload function execution unit 204 receives an “execution result” from the accelerator 205 as an input. In the <result response pattern>, the offload function execution unit 204 passes the “function name and function execution result” to the ACC function and return value data packetization unit 330 of the NIC hardware 300 as an output.

[NIC hardware 300]

As illustrated in FIGS. 1 and 2, the NIC hardware 300 is an NIC unit provided on the server 200 side, and includes an L3/L4 protocol and ACC function data parsing unit (hereinafter referred to as an ACC function data parsing unit) 310, a data transfer unit 320, and an L3/L4 protocol and ACC function and return value data packetization unit (hereinafter referred to as an ACC function and return value data packetization unit) 330.

### <ACC Function Data Parsing Unit 310>

The ACC function data parsing unit 310 deserializes the packet data input from the client 100 side according to a predetermined protocol format, and acquires the function name and multiple arguments from the input data. The ACC function data parsing unit 310 instructs the data transfer unit 320 to transfer data to the ACC argument recording unit 201. In this case, when the final packet is detected, the data transfer unit 320 is also instructed to transfer data to the ACC function execution trigger recording unit 202.

The format of the data to be parsed by the ACC function data parsing unit 310 is illustrated in FIG. 3.

FIG. 3 is a diagram illustrating a configuration example of the ACC function and argument data packet 400.

The ACC function and argument data packet 400 consists of L2 frame (0 to 14 bytes), L3 header (˜34 bytes), L4 header (˜42 bytes), control bit (˜46 bytes), function ID (˜50 bytes), argument 1 (˜54 bytes), and argument 2 (˜58 bytes).

The ACC function and argument data packet 400 has a data structure suitable for parsing in the FPGA circuit by fixing the length and position of each data.

The control bit adds control information for the packet. The ACC function data parsing unit 310 has, for example, a function of dividing a packet into multiple packets when the argument size is large. In this case, in the last divided packet, control data for notifying the final packet is added to the “control bit”.

Note that the packet format illustrated in FIG. 3 may include not only the function name and arguments, but also an ID that can uniquely identify the accelerator to be used.

Returning to FIGS. 1 and 2, the ACC function data parsing unit 310 receives a “reception packet” from the NIC unit 111 of the client 100, which is the communication partner, as an input. The ACC function data parsing unit 310 passes the transfer destination (the ACC argument recording unit 201) and “function name and argument data” to the data transfer unit 320 as an output.

Note that when the final packet is detected from the input packet, the data transfer unit 320 is instructed to transfer data to the ACC function execution trigger recording unit 202.

The computation offloading system 1000 is characterized in that it is a dedicated one eliminating multiple protocol processes required in the conventional technology by including the ACC function data parsing unit 310 having a single dedicated function.

As a result, the computation offloading system 1000 can reduce overhead and increase the processing speed by reducing the number of times of selection and copy with the linkage of data on the server 200 side.

### <Data Transfer Unit 320>

The data transfer unit 320 is a data transfer functional unit in the NIC hardware 300, and transfers input data to the memory area of a host machine.

The data transfer unit 320 receives two pieces of data including “transfer destination” and “transfer target data” from the ACC function data parsing unit 310 as an input. The data transfer unit 320 passes the “transfer target data” to the designated transfer destination as an output. A typical example is the DMA (Direct Memory Access) function.

### <ACC Function and Return Value Data Packetization Unit 330>

The ACC function and return value data packetization unit 330 serializes the function name and arguments input from the accelerator 205 according to a predetermined protocol format, and packetizes it as a payload.

The ACC function and return value data packetization unit 330 is a function that converts the input function name and function execution result into data as UDP/IP packets and their payloads.

The ACC function and return value data packetization unit 330 serializes the input function name and function execution result according to a predetermined format to convert them into a single piece of data.

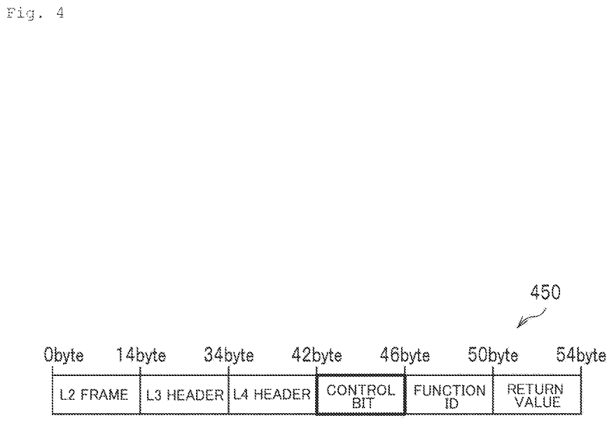

FIG. 4 is a diagram illustrating a configuration example of the ACC function and return value packet 450.

The ACC function and return value packet 450 is the format of the ACC function and return value data of the ACC function and return value data packetization unit 330.

The ACC function and return value packet 450 consists of L2 frame (0 to 14 bytes), L3 header (˜34 bytes), L4 header (˜42 bytes), control bit (˜46 bytes), function ID (˜50 bytes), and return value (˜54 bytes)).

The control bit adds control information for the packet. The ACC function and return value data packetization unit 330 has a function of dividing a packet into multiple packets, for example, when the argument size is large. In this case, in the last divided packet, control data for notifying the final packet is added to the “control bit”.

Note that the packet format illustrated in FIG. 4 may include not only the function name and arguments, but also an ID that can uniquely identify the accelerator to be used.

Further, when the ACC function and return value data packetization unit 330 has a function of dividing a packet into multiple packets, the ACC function and argument data packet generation unit 133 of the UserLAnd APL 130 of the client 100 also has a binding function.

Returning to FIGS. 1 and 2, the ACC function and return value data packetization unit 330 receives “function name and arguments” from the offload function execution unit 204 as an input. The ACC function and return value data packetization unit 330 passes the “transmission packet” to the NIC unit 111 of the client 100 as an output.

Similarly to the ACC function and argument data packet generation unit 133, in the ACC function and return value data packetization unit 330, the L3/L4 protocol may be TCP/IP, SCTP (Stream Control Transmission Protocol)/IP, or the like other than UDP (User Datagram Protocol)/IP. Also, only L3 may be used instead of using both L3/L4. Specifically, a configuration is conceivable in which IP is used for L3 and a dedicated protocol defined by the user is used for L4 and above.

Alternatively, only the L4 protocol may be integrated with the ACC function and return value data packetization unit 330, and the L3 protocol may use the general-purpose protocol stack of an OS.

As described above, the NIC hardware 300 includes the ACC function data parsing unit 310, the data transfer unit 320, and the ACC function and return value data packetization unit 330, and has the following features.

That is, the ACC function and return value data packetization unit 330 is characterized in that it is a single dedicated function in which the ACC function and return value packetization unit 84 on the APL 80 side and the L4/L3 protocol stack unit 71 of the OS 70 in the accelerator standard IF offloading system of the conventional technology illustrated in FIG. 16 are combined. Similarly, the ACC function data parsing unit 310 is characterized in that it is a single dedicated function in which the ACC function and argument data parsing unit 82 on the APL 80 side and the L4/L3 protocol stack unit 71 of the OS 70 in the accelerator standard IF offloading system of the conventional technology illustrated in FIG. 16 are combined.

As a result, the computation offloading system 1000 can reduce overhead and increase the processing speed by reducing the number of times of selection and copy with the linkage of data on the server 200 side.

### [NIC Hardware 300]

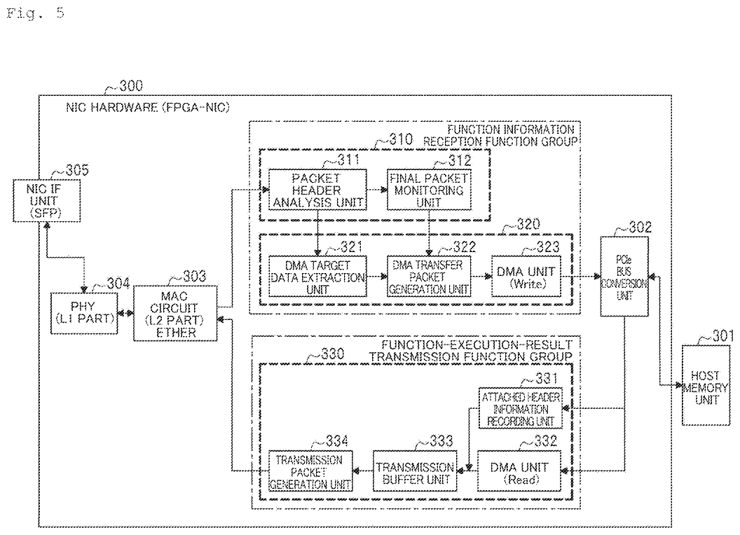

FIG. 5 is a functional block diagram of the NIC hardware 300 illustrated in FIGS. 1 and 2. The NIC hardware 300 in FIG. 5 is an example (FPGA NIC) in which the NIC functional unit is implemented using an FPGA.

As illustrated in FIG. 5, the NIC hardware (FPGA NIC) 300 includes a PCIe bus conversion unit 302 that transmits and receives data to and from an external host memory unit 301, a packet header analysis unit 311, a final packet monitoring unit 312, a DMA target data extraction unit 321, a DMA transfer packet generation unit 322, a DMA unit (Write) 323, an attached header information recording unit 331, a DMA unit (Read) 323, a transmission buffer unit 333, a transmission packet generation unit 334, a circuit 303, an MAC circuit (L2 unit) 303, a PHY (L1 unit) 304, and an NIC IF unit (SFP) 305.

The packet header analysis unit 311 and the final packet monitoring unit 312 constitute the ACC function data parsing unit 310 illustrated in FIGS. 1 and 2.

The DMA target data extraction unit 321, the DMA transfer packet generation unit 322 and the DMA unit (Write) 323 constitute the data transfer unit 320 illustrated in FIGS. 1 and 2.

Also, the packet header analysis unit 311, the final packet monitoring unit 312, the DMA target data extraction unit 321, the DMA transfer packet generation unit 322, and the DMA unit (Write) 323 constitute <function information reception function group> as a whole.

The attached header information recording unit 331, the DMA unit (Read) 323, the transmission buffer unit 333, and the transmission packet generation unit 334 constitute the ACC function and return value data packetization unit 330 illustrated in FIGS. 1 and 2. Also, the attached header information recording unit 331, the DMA unit (Read) 323, the transmission buffer unit 333, and the transmission packet generation unit 334 constitute <function-execution-result transmission function group>.

The operation of the computation offloading system 1000 configured as described above will be described below.

### [Outline of Operation of Computation Offloading System 1000]

The offloading processing flow of the computation offloading system 1000 will be described with reference to FIG. 2. In the description of FIG. 2, the same offloading processing flow as in FIG. 16 is denoted by the same reference signs.

The solid-line arrow in FIG. 2 indicates the offload forward path, and the dashed-line arrow in FIG. 2 indicates the offload backward path.

### Offload Forward Path

As illustrated in FIG. 2, the ACC function proxy reception unit 132 of the UserLAnd APL 130 of the client 100 receives “function name and arguments” from the user application unit 131 as an input (see symbol a in FIG. 2). The ACC function proxy reception unit 132 of the client 100 passes the “function name and arguments” to the ACC function and argument data packet generation unit 133 of the OS 120 as an output (see symbol b in FIG. 2).

The ACC function and argument data packet generation unit 133 of the OS 120 receives “function name and arguments” from the ACC function proxy reception unit 132 as an input (see symbol b in FIG. 2). The ACC function and argument data packet generation unit 133 converts the input function name and arguments into data as UDP/IP packets and their payloads. The ACC function and argument data packet generation unit 133 serializes the input function name and multiple arguments according to a predetermined format into a single piece of data. The ACC function and argument data packet generation unit 133 passes the “transmission packet” to the packet processing inline inserting unit 121 as an output (see symbol c in FIG. 2).

In the <transmission pattern>, the packet processing inline inserting unit 121 of the OS 120 receives a “transmission packet” from the ACC function and argument data packet generation unit 133 as an input. The packet processing inline inserting unit 121 exchanges the input packet data with the device driver without using the existing protocol stack. In the <transmission pattern>, the packet processing inline inserting unit 121 passes the “transmission packet” to the NIC driver unit 122 as an output (see symbol q in FIG. 2).

In the <transmission pattern>, the NIC driver unit 122 of the OS 120 receives the “transmission packet” from the packet processing inline inserting unit 121 as an input. The NIC driver unit 122 abstracts an interface unique to each NIC type. In the <transmission pattern>, the NIC driver unit 122 passes a “transmission packet” to the NIC 111 as an output (see symbol d in FIG. 2).

The NIC 111 transmits packets to the NIC hardware 300 connected via the NW1.

The ACC function data parsing unit 310 of the NIC hardware 300 receives packets from the NIC 111 of the client 100 (see symbol q in FIG. 2).

The ACC function data parsing unit 310 deserializes the input packet data, acquires the function name and multiple arguments from the input data, and instructs the data transfer unit 320 to transfer data to the ACC argument recording unit 201 of the server 200. When the ACC function data parsing unit 310 detects the final packet, the ACC function data parsing unit 310 also instructs the data transfer unit 320 to transfer data to the ACC function execution trigger recording unit 202 of the server 200. The format of data to be parsed by the ACC function data parsing unit 310 is illustrated in FIG. 3.

The data transfer unit 320 receives the “transfer destination” and “transfer target data” from the ACC function data parsing unit 310 as an input, and passes the “transfer target data” to the specified transfer destination as an output (see symbol r in FIG. 2).

The ACC argument recording unit 201 of the UserLAnd APL 230 of the server 200 receives and records the “transfer target data” from the data transfer unit 320 as an input.

The ACC function execution trigger recording unit 202 records whether the arguments recorded in the ACC argument recording unit 201 are complete and the ACC function is executable. The ACC function execution trigger recording unit 202 receives an executable trigger from the data transfer unit 320 as an input, and the data transfer unit 320 updates the state.

The ACC function execution trigger confirmation unit 203 constantly monitors the ACC function execution trigger recording unit 202 as an input (see symbol s in FIG. 2) and confirms whether it is in an executable state. The ACC function execution trigger confirmation unit 203 refers to the ACC function execution trigger recording unit 202, and detects that the offload function execution unit 204 can execute the ACC function based on the data recorded in the ACC argument recording unit 201 (see symbol t in FIG. 2).

The offload function execution unit 204 executes the accelerator function based on the input function name and arguments, and links the result to the accelerator 205 of the server HW 210.

In the <execution pattern>, the offload function execution unit 204 receives “function name and arguments” from the ACC argument recording unit 201 as an input. In the <execution pattern>, the offload function execution unit 204 passes “ACC instruction data” to the accelerator 205 as an output (see symbol u in FIG. 2).

### Offload Backward Path

In the <transmission pattern>, the accelerator 205 passes the “execution result” to the offload function execution unit 204 (see symbol v in FIG. 2).

In the <result response pattern>, the offload function execution unit 204 receives an “execution result” from the accelerator 205 as an input. In the <result response pattern>, the offload function execution unit 204 passes the “function name and function execution result” to the ACC function and return value data packetization unit 330 of the NIC hardware 300 as an output (see symbol w in FIG. 2).

The ACC function and return value data packetization unit 330 receives the “function name and arguments” from the offload function execution unit 204 as an input. The ACC function and return value data packetization unit 330 converts the input function name and function execution result into data as UDP/IP packets and their payloads. Further, the ACC function and return value data packetization unit 330 serializes the input function name and function execution result according to a predetermined format to convert them into a single piece of data. The ACC function and return value data packetization unit 330 passes the “transmission packet” to the NIC unit 111 of the client 100 as an output (see symbol x in FIG. 2).

The NIC driver unit 122 of the client 100 receives the packet from the NIC 111 and passes it to the packet processing inline inserting unit 121 (see symbol m in FIG. 2).

In the <reception pattern>, the packet processing inline inserting unit 121 receives a “reception packet” from the NIC driver unit 122 as an input. The packet processing inline inserting unit 121 exchanges the input packet data with the device driver without using the existing protocol stack. In the <reception pattern>, the packet processing inline inserting unit 121 passes the “reception packet” to the ACC function and response data parsing unit 134 as an output (see symbol n in FIG. 2).

The ACC function and response data parsing unit 134 obtains the function name and execution result from the input data by deserializing the input packet data, and passes them to the ACC function proxy response unit 135 (see symbol o in FIG. 2).

The ACC function proxy response unit 135 receives the “function name and execution result” from the ACC function and response data parsing unit 134 as an input. The ACC function proxy response unit 135 executes the ACC function proxy response by middleware having an IF compatible with a specified API. The ACC function proxy response unit 135 passes a “return value” to the user application unit 131 as an output (see symbol p in FIG. 2).

The user application unit 131 receives function execution results from the ACC function proxy response unit 135.

In the computation offloading system 1000 of the present embodiment, the OS 120 deploys a dedicated function (the ACC function and argument data packet generation unit 133, the ACC function and response data parsing unit 134, the ACC function and return value data packetization unit 330, and the ACC function data parsing unit 310) for the “L3/L4 protocol stack” and the “ACC function and argument data” for each of the “parse function” and “packet generation function” as an internal function of the OS.

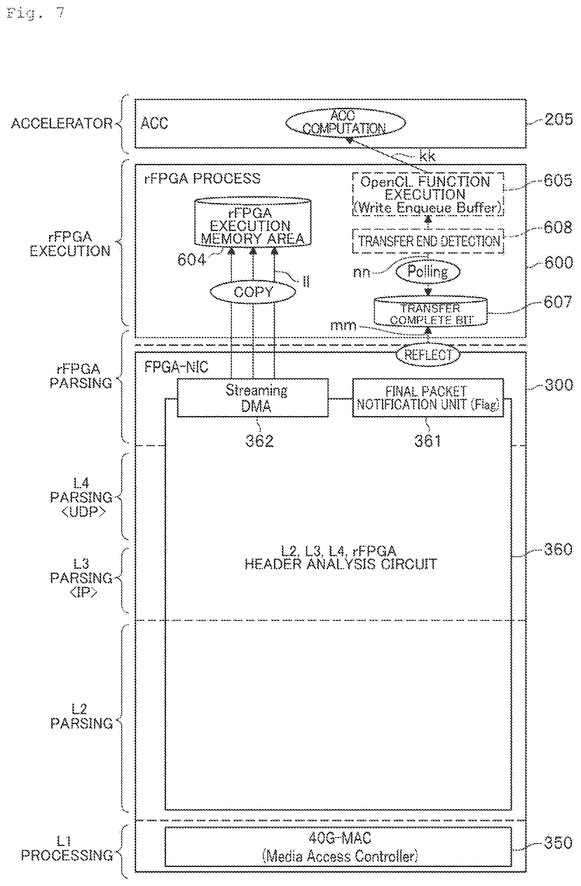

As a result, since the dedicated function operates as the internal function of the OS, the overhead due to data linkage between the APL and the OS can be reduced (which will be described in comparison with FIGS. 6 and 7 below).

Further, the dedicated function is linked with the NIC driver unit 122 by the packet processing inline inserting unit 121. As a result, since the dedicated function is linked with the NIC driver unit 122 by the packet processing inline inserting unit 121, the overhead between the NIC driver unit 122 and the dedicated function can be reduced.

Next, overhead due to data linkage between the APL and the OS will be described.

### [Overhead Due to Data Linkage Between APL and OS]

FIGS. 6 and 7 are diagrams for explaining overhead due to data linkage between the APL and the OS.

### <<Middleware Processing of Conventional Technology>>

FIG. 6 is a diagram for explaining an outline of middleware processing in a reception unit of a client of the conventional technology. This middleware processing takes the Socket-based remote ACC utilization middleware processing as an example. Socket-based remote ACC utilization middleware can use rCUDA (Remote Compute Unified Device Architecture).

### <OS Kernel 500>

As illustrated in FIG. 6, in the OS kernel 500, an NIC driver (HIRD handler) 501, which is a handler that is called when a processing request is generated from the NIC 61 (physical NIC), which is a network interface card, and executes the requested processing (hardware interrupt) is disposed.

The OS kernel 500 receives a hardware interrupt (HW) (see symbol aa in FIG. 6) or a software interrupt (SW) (see symbol bb in FIG. 6). In the OS kernel 500, Soft IRQ handler processing and packet reception processing 502 is a handler which is called (queuing) when a processing request is generated from the NIC driver (HIRD handler) 501 (see symbol cc in FIG. 6) and executes the requested packet reception processing (software interrupt), Soft IRQ handler processing and L2 and L3 protocol processing 503 which is a handler that receives the packet reception processing and executes L2 and L3 protocol processing (software interrupt), and packet pruning processing (NAPI) 504 that repeats the Soft IRQ handler processing and L2 and L3 protocol processing 503 to perform packet pruning processing (NAPI) are disposed. Pruning of queues refers to referring to the content of packets stored in a buffer and deleting the entry of the corresponding queue from the buffer in consideration of the processing of the packets and the processing to be performed next.

In the OS kernel 500, Soft IRQ handler processing and L4 protocol processing 505, which is a handler that receives the Soft IRQ handler processing and L2 and L3 protocol processing 503 and executes Soft IRQ handler processing and L4 protocol processing (software interrupts) is disposed. Also, outside the OS kernel 500, a Socket Queue 507 storing a queue generated by the Soft IRQ handler processing and L4 protocol processing 506 is disposed (see symbol ee in FIG. 6).

<rFPGA 600>

An rFPGA 600 is divided into an rFPGA parse and an rFPGA execution unit, and the rFPGA parse receives software interrupts (SW) (see symbol ff in FIG. 6).

In the rFPGA 600, a Socket reception buffer 602, rFPGA parse (binding) and transfer end detection processing 603, an rFPGA execution memory area 604, and a Write Enqueue Buffer 605 are disposed.

The socket reception buffer 602 copies the output of the Socket Queue 507 sent via the Socket API 601 (see symbol gg in FIG. 6) and temporarily stores the same.

The rFPGA parse (binding) and transfer end detection processing 603 receives data stored in the Socket reception buffer 602 (see symbol hh in FIG. 6), and performs rFPGA parse (binding) and transfer end detection.

The rFPGA execution memory area 604 copies (see symbol jj in FIG. 6) and stores the results of the rFPGA parse (binding) and transfer end detection processing 603.

The Write Enqueue Buffer 605 executes the OpenCL function based on the rFPGA parsed (bound) data from the rFPGA execution memory area 604.

### <Accelerator 62>

The accelerator 62 receives the OpenCL function execution result held in the Write Enqueue Buffer 605 (see symbol kk in FIG. 6) and executes ACC computation.

In the Socket-based remote ACC utilization middleware processing of the conventional technology illustrated in FIG. 6, overhead (overhead due to the processing of selecting the L4/L3 protocol stack with multiple processes and overhead due to the NIC driver exchanging data via the existing protocol stack) occurs in the Soft IRQ handler processing and L2, L3 protocol processing 503 and the Soft IRQ handler processing and L4 protocol processing 505 of the OS kernel 500, and the Socket reception buffer 602 and the rFPGA parsing (binding) and transfer end detection processing 603 of the rFPGA 600.

### <<Processing of NIC Hardware 300 of Computation Offloading System 1000>>

FIG. 7 is a diagram explaining an outline of the processing of the NIC hardware 300 of the computation offloading system of the present embodiment. In the description of FIG. 7, the same processes as those in FIGS. 2, 5 and 6 are denoted by the same reference signs, and the description of overlapping portions is omitted.

### <NIC Hardware 300>

The computation offloading system of the present embodiment is configured by replacing the NIC on the server side with the NIC hardware 300 illustrated in FIG. 5. The NIC hardware 300 illustrated in FIG. 5 is an rFPGA constituted by hardware. In the computation offloading system illustrated in FIG. 7, the OS kernel 500 in FIG. 6 and the rFPGA parse of the rFPGA 600 in FIG. 6 are replaced with the NIC hardware 300 (see FIG. 5) configured by FPGA-NIC. In the case of FIG. 7, in the NIC hardware 300, L1 processing is configured by a 40G-MAC 350, and L2 parse, L3 parse, L4 parse, and rFPGA parse are configured by an L2, L3, L4, and rFPGA header analysis circuit 360. The NIC hardware 300 also includes a final packet notification unit 361 and a Streaming DMA362.

As illustrated in FIG. 7, the rFPGA parse of the rFPGA 600 is incorporated in the NIC hardware 300, so the rFPGA execution unit of the rFPGA 600 is configured such that a transfer end detection 608 by polling (see symbol nn in FIG. 7) is disposed between the transfer completion bit 607 that reflects the notification from the NIC hardware 300 (see symbol mm in FIG. 7) and the Write Enqueue Buffer 605. A copy of the Streaming DMA 362 is directly transferred to the rFPGA execution memory area 604 (see symbol 11 in FIG. 7).

As a result, the computation offloading system illustrated in FIG. 7 has reduced latency compared to the Socket-based remote ACC utilization middleware illustrated in FIG. 6 due to the following three features.

### (1) Reduced Number of Memory Copies in CPU

Compared to the Socket-based remote ACC utilization middleware illustrated in FIG. 6, it is possible to reduce the number of binding copies during buffer copy parsing when each packet is received.

### (2) Reduced Number of Interrupts

DMA transfer is performed directly from the L2, L3, L4, rFPGA header analysis circuit 360, and the end is detected by polling, so the number of interrupts and overhead can be reduced.

### (3) Faster Speed Due to Use of Parsing Circuit

Since the parsing process is realized by hardware (HW) based on, for example, SRAM (Static Random Access Memory), faster speed can be achieved.

### [Offloading Processing of Computation Offloading System 1000]

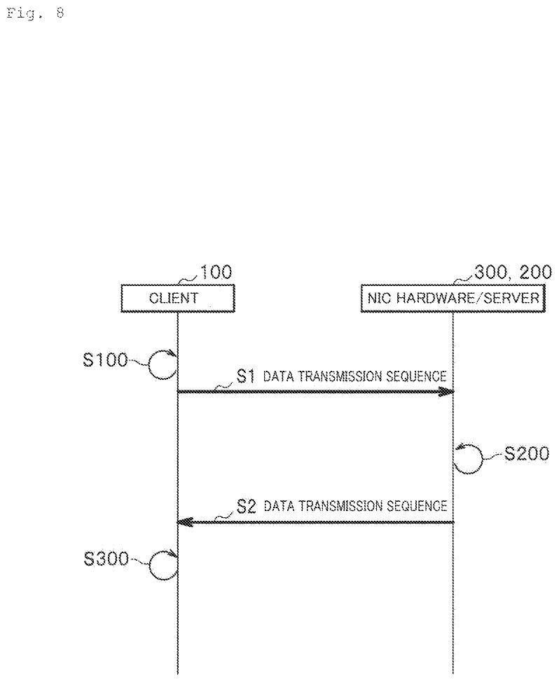

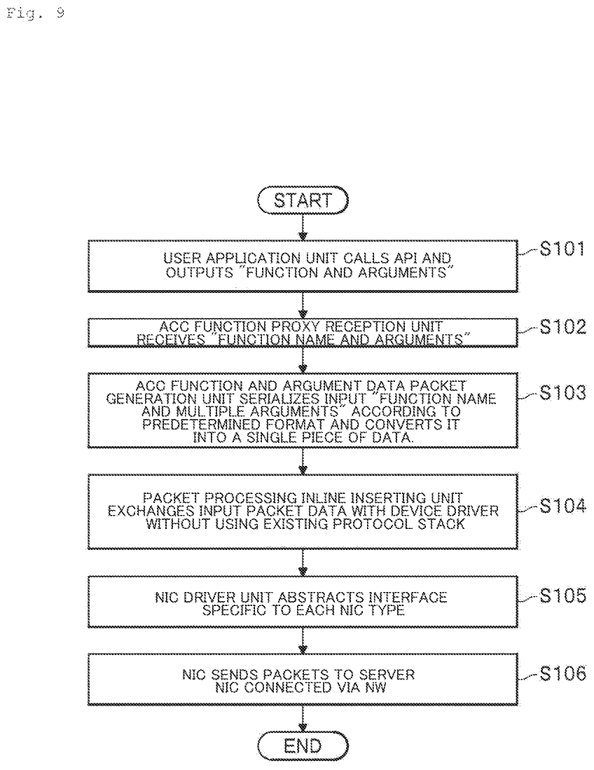

Next, the offloading processing of the computation offloading system 1000 will be described with reference to the control sequence of FIG. 8 and the flowcharts of FIGS. 9 to 11.

FIG. 8 is a control sequence illustrating offloading processing of the computation offloading system 1000 of FIGS. 1 and 2.

As illustrated in FIG. 8, the client 100 (see FIGS. 1 and 2) executes offloading processing (S100; see FIG. 9) at the time of transmission, and sends the processing result to the NIC hardware 300 and the server 200 (see FIGS. 1 and 2) via the NW1 (see FIGS. 1 and 2) (S1; see data transmission sequence).

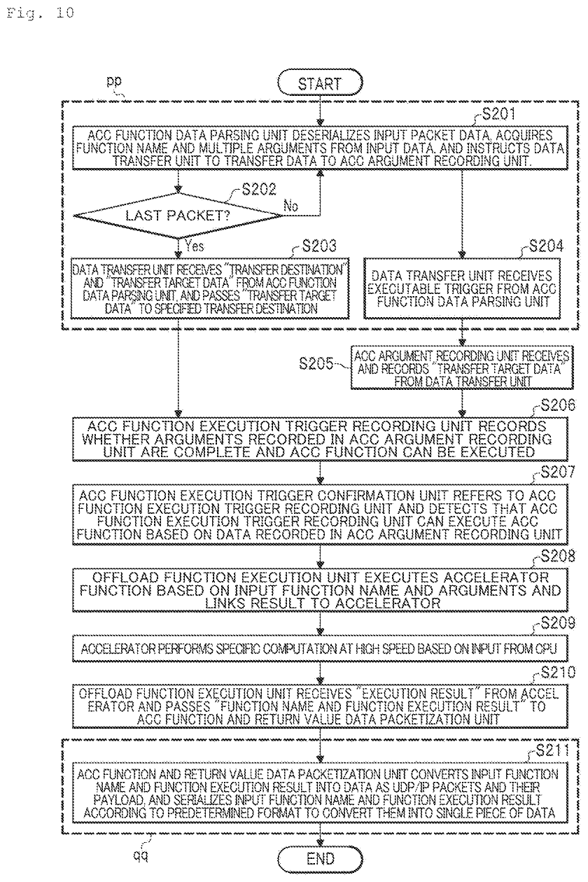

The NIC hardware 300 and the server 200 receive data from the client 100 transmitted via the NW1 and perform offloading processing (S200; see FIG. 10) in the server.

The server 200 and the NIC hardware 300 transmit the ACC function processing result to the client 100 via the NW1 (see $2; data transmission sequence).

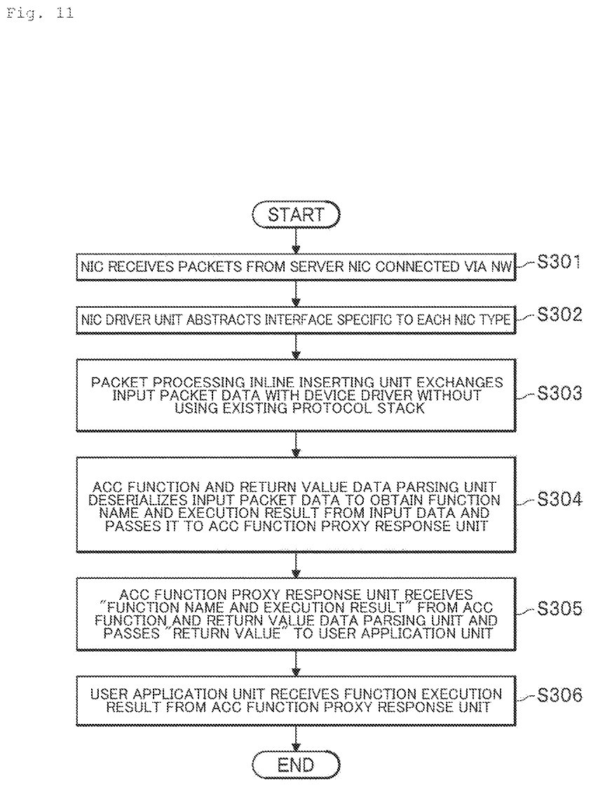

The client 100 executes offloading processing (S300; see FIG. 11) at the time of reception.

FIG. 9 is a flowchart illustrating offloading processing (processing of S100 in FIG. 8) at the time of transmission by the client 100 of the computation offloading system 1000 in FIGS. 1 and 2.

In step S101, the user application unit 131 makes an API call and outputs “function name and arguments”.

In step S102, the ACC function proxy reception unit 132 receives the “function name and arguments” from the user application unit 131 and passes the “function name and arguments” to the ACC function and argument data packet generation unit 133.

In step S103, the ACC function and argument data packet generation unit 133 serializes the input “function name and multiple arguments” according to a predetermined format, converts it into a single piece of data, and outputs it as a “transmission packet”.

In step S104, the packet processing inline inserting unit 121 exchanges the input packet data (“transmission packet”) with the device driver (the NIC driver unit 122) without using the existing protocol stack.

In step S105, the NIC driver unit 122 receives the “transmission packet” from the packet processing inline inserting unit 121, abstracts it into an interface specific to each NIC type, and passes it to the NIC 111.

In step S106, the NIC 111 transmits the packet to the NIC hardware 300 connected via the NW1.

FIG. 10 is a flowchart illustrating offloading processing (processing of S200 in FIG. 8) of the NIC hardware 300 and the server 200 of the computation offloading system 1000 in FIGS. 1 and 2.

In step S201, the ACC function data parsing unit 310 of the NIC hardware 300 deserializes the packet data input from the client 100 side according to a predetermined protocol format, and instructs the data transfer unit 320 to transfer the data to the ACC argument recording unit 201.

In step S202, the ACC function data parsing unit 310 determines whether or not it is the final packet, and if it is not the final packet, the processing returns to step S201. In the case of the final packet, the processing proceeds to step S203. As described above, the ACC function data parsing unit 310 confirms that it is the last divided packet by confirming the control data (see FIG. 3) added to the “control bit” of the packet.

In step S203, the data transfer unit 320 of the NIC hardware 300 receives the “transfer destination” and “transfer target data” from the ACC function data parsing unit 310, and delivers the “transfer target data” to the specified transfer destination.

On the other hand, in step S204, the data transfer unit 320 receives “executable trigger” from the ACC function data parsing unit 310.

As described above, steps S201 to S204 surrounded by the dashed box pp in FIG. 10 are the functions executed by the NIC hardware 300. Thereafter, steps S205 to S210 are executed by the server 200, and are executed again by the NIC hardware 300 in step S211 (see the dashed box qq in FIG. 10).

In step S205, the ACC argument recording unit 201 receives and records the “transfer target data” from the data transfer unit 320.

In step S206, the ACC function execution trigger recording unit 202 records whether the arguments recorded in the ACC argument recording unit 201 are complete and the ACC function is executable.

In step S207, the ACC function execution trigger confirmation unit 203 refers to the ACC function execution trigger recording unit 202, and detects that the offload function execution unit 204 can execute the ACC function based on the data recorded in the ACC argument recording unit 201.

In step S208, the offload function execution unit 204 executes the accelerator function based on the input function name and arguments, and links the result to the accelerator 205.

In step S209, the accelerator 205 performs a specific computation at high speed based on the input from the CPU.

In step S210, the offload function execution unit 204 receives the “execution result” from the accelerator 205 and passes the “function name and function execution result” to the ACC function and return value data packetization unit 330 of the NIC hardware 300.

In step S211, the ACC function and return value data packetization unit 330 of the NIC hardware 300 converts the input function name and function execution result into data as UDP/IP packets and their payloads, and serializes the input function name and function execution result according to a predetermined format to convert them into a single piece of data.

FIG. 11 is a flowchart illustrating offloading processing (processing of S300 in FIG. 8) at the time of reception by the client 100 of the computation offloading system 1000 in FIGS. 1 and 2.

In step S301, the NIC 111 of the client 100 receives packets from the NIC hardware 300 connected via the NW1.

In step S302, the NIC driver unit 122 receives a “reception packet” from the NIC 111, abstracts it into an interface unique to each NIC type, and passes it to the packet processing inline inserting unit 121.

In step S303, the packet processing inline inserting unit 121 exchanges the input packet data (“reception packet”) with the device driver (the NIC driver unit 122) without using the existing protocol stack, and passes the “reception packet” to the ACC function and response data parsing unit 134.

In step S304, the ACC function and response data parsing unit 134 acquires the function name and execution result from the input data by deserializing the input packet data, and passes them to the ACC function proxy response unit 135.

In step S305, the ACC function proxy response unit 135 receives the “function name and execution result” from the ACC function and response data parsing unit 134, and passes the “return value” to the user application unit 131.

In step S306, the user application unit 131 receives the function execution result from the ACC function proxy response unit 135.

### [Modifications]

### <Modification 1>

In the computation offloading system 1000 of FIGS. 1 and 2, the accelerator offloading on the server side is performed by the CPU. However, as in <Modification 1>, the accelerator offloading processing may be performed inside the NIC hardware 300 (the NIC with parsing function: the NIC capable of processing high-performance L2/L3/L4/ACC function arguments).

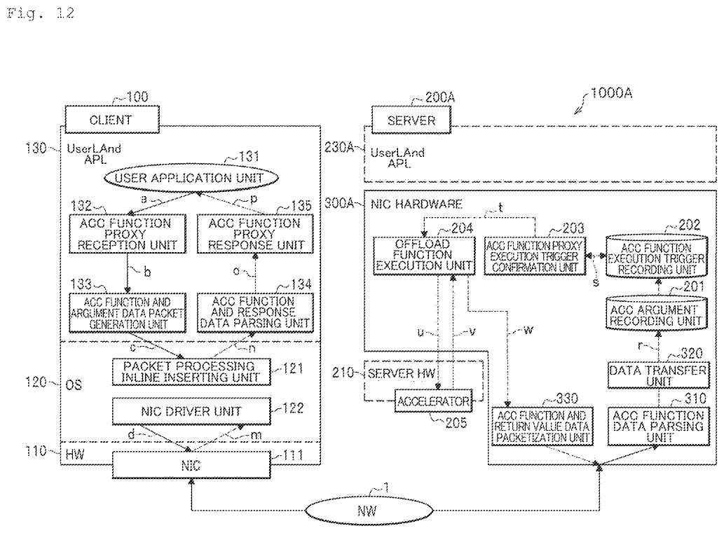

FIG. 12 is a schematic configuration diagram of a computation offloading system according to <Modification 1> of the embodiment of the present invention. The same components and operations as those in FIGS. 1 and 2 are denoted by the same reference signs, and the description of overlapping portions is omitted.

As illustrated in FIG. 12, a computation offloading system 1000A according to <Modification 1> includes a server 200A and NIC hardware 300A.

In the server 200A, the ACC argument recording unit 201, the ACC function execution trigger recording unit 202, the ACC function execution trigger confirmation unit 203, and the offload function execution unit 204 of the UserLAnd APL 230 of the server 200 in FIG. 2 are transferred to the NIC hardware 300A. Therefore, the UserLAnd APL 230A of the server 200A does not have the functional units described above.

In the computation offloading system 1000A according to <Modification 1>, the accelerator offloading processing is performed inside the NIC hardware 300A equipped with the ACC function data parsing unit 310 and the data transfer unit 320, and the result is sent to the server 200A. As a result, accelerator offloading can be performed without using the CPU on the server 200A side, and the processing load on the server 200A can be reduced. In addition, since the NIC hardware 300A is configured by hardware (HW), faster speed can be achieved.

### <Modification 2>

In the computation offloading system 1000 in FIGS. 1 and 2, an example in which the NIC hardware 300 (the NIC with parsing function: the NIC capable of processing high-performance L2/L3/L4/ACC function arguments) is deployed in the server-side NIC has been described.

The high-performance NIC (the NIC hardware 300) may be mounted on both the client side and the server, or only the client side.

Hereinafter, In <Modification 2>, an example in which the NIC hardware 300B is mounted on the client will be described.

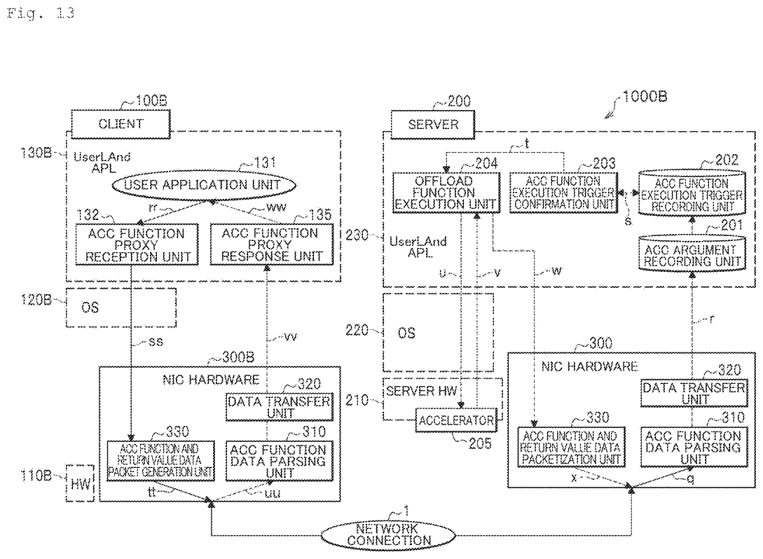

FIG. 13 is a schematic configuration diagram of a computation offloading system according to <Modification 2> of the embodiment of the present invention. The same components and operations as those in FIGS. 1 and 2 are denoted by the same reference signs, and the description of overlapping portions is omitted.

As illustrated in FIG. 13, a computation offloading system 1000B according to <Modification 2> includes a client 100B and NIC hardware 300B on the client side.

The client 100B includes client HW 110B, an OS 120B, and a UserLAnd APL 130B.

The client HW 110B does not have the NIC 111 of FIGS. 1 and 2, and the OS 120B does not have the packet processing inline inserting unit 121 and the NIC driver unit 122 of FIGS. 1 and 2. The UserLAnd APL 130B does not have the ACC function and argument data packet generation unit 133 and the ACC function and response data parsing unit 134 of the UserLAnd APL 130 in FIGS. 1 and 2.

The NIC hardware 300B has the same configuration as the NIC hardware 300 of the server 200. That is, the NIC hardware 300B, 300 (the NIC with parsing function: the NIC capable of processing high-performance L2/L3/L4/ACC function arguments) is mounted on both the client side and the server.

### Offload Forward Path (Only Client Side Will be Described)

As illustrated in FIG. 13, the ACC function proxy reception unit 132 of the UserLAnd APL 130B of the client 100B receives “function name and arguments” from the user application unit 131 as an input (see symbol rr in FIG. 13). The ACC function proxy reception unit 132 of the client 100B passes the “function name and function execution result” to the ACC function and return value data packetization unit 330 of the NIC hardware 300B without using the OS 120B as an output (see symbol ss in FIG. 13). The ACC function and return value data packetization unit 330 passes the “transmission packet” to the NIC hardware 300 on the server 200 side as an output (see symbol tt in FIG. 13).

### Offload Backward Path (Only Client Side Will be Described)

The ACC function data parsing unit 310 of the NIC hardware 300B on the client 100B side receives the packet from the NIC hardware 300 on the server 200 side (see symbol uu in FIG. 13).

The ACC function data parsing unit 310 of the NIC hardware 300B deserializes the input packet data, acquires the function name and multiple arguments from the input data, and instructs the data transfer unit 320.

The data transfer unit 320 of the NIC hardware 300B passes the function name and execution result to the ACC function proxy response unit 135 (see symbol vv in FIG. 13).

The ACC function proxy response unit 135 of the UserLAnd APL 130B of the client 100B passes the “return value” to the user application unit 131 as an output (see symbol ww in FIG. 13).

As a result, in the computation offloading system 1000B illustrated in FIG. 13, it is possible to achieve, on the client side, (1) reduced number of memory copies in CPU, (2) reduced number of interrupts, and (3) faster speed due to use of parsing circuit.

### [Hardware Configuration]

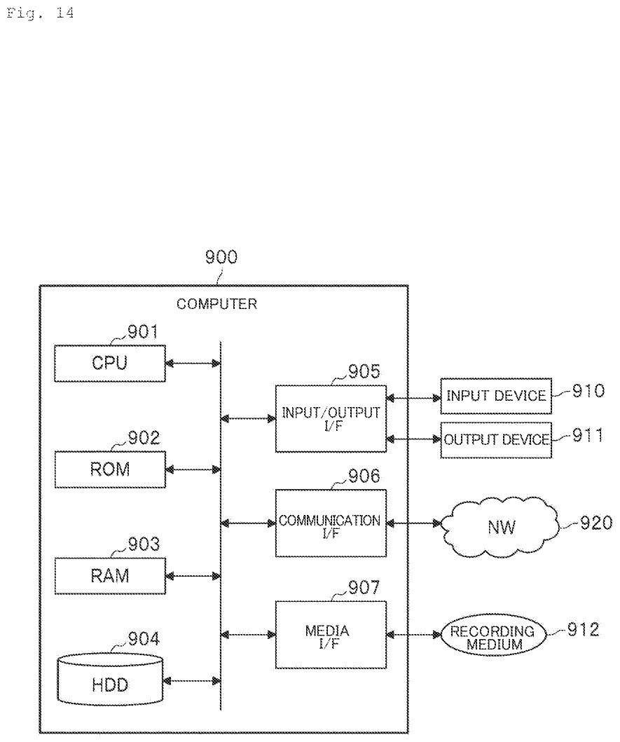

The client 100, 100B or the server 200, 200A of the computation offloading system 1000, 1000A, 1000B according to the present embodiment is implemented, for example, by a computer 900 configured as illustrated in FIG. 14 (hereinafter, the client 100 will be described as a representative).

FIG. 14 is a hardware configuration diagram illustrating an example of a computer 900 that implements the functions of the client 100.

The computer 900 has a CPU 901, a ROM 902, a RAM 903, an HDD 904, a communication interface (I/F) 906, an input/output interface (I/F) 905 and a media interface (I/F) 907.

The CPU 901 operates based on programs stored in the ROM 902 or HDD 904, and controls each unit of the client 100 illustrated in FIG. 1. The ROM 902 stores a boot program to be executed by the CPU 901 when the computer 900 is started up, a program that relies on the hardware of the computer 900, and the like.

The CPU 901 controls an input device 910 such as a mouse and a keyboard and an output device 911 such as a display via the input/output I/F 905. The CPU 901 acquires data from the input device 910 and outputs generated data to the output device 911 via the input/output I/F 905. A GPU (Graphics Processing Unit) or the like may be used as the processor together with the CPU 901.

The HDD 904 stores a program executed by the CPU 901, data used by the program, and the like. The communication I/F 906 receives data from other devices via a communication network (for example, network (NW) 920), outputs the data to the CPU 901, and transmits data generated by the CPU 901 to other devices via the communication network.

The media I/F 907 reads a program or data stored in a recording medium 912 and outputs the data to the CPU 901 via the RAM 903. The CPU 901 loads the program according to processing of a purpose from the recording medium 912 on the RAM 903 via the media I/F 907 and executes the loaded program. The recording medium 912 is an optical recording medium such as a digital versatile disc (DVD), a phase change rewritable disk (PD), a magneto-optical recording medium such as a magneto optical disk (MO), a magnetic recording medium, a conductor memory tape medium, a semiconductor memory, or the like.

For example, when the computer 900 functions as the client 100 configured as one device according to the present embodiment, the CPU 901 of the computer 900 implements the functions of the client 100 by executing programs loaded on the RAM 903. Further, data in the RAM 903 is stored in the HDD 904. The CPU 901 reads a program related to target processing from the recording medium 912 and executes the program. In addition, the CPU 901 may read a program related to the target processing from another device via the communication network (NW 920).

Although the client 100 of the computation offloading system 1000 according to the present embodiment has been described above, the server 200 can also be implemented by the computer 900 having a similar configuration.

### [Effects]

As described above, in the computation offloading system 1000 (see FIGS. 1 and 2) which includes the client 100 and the server 200 connected via the network and the NIC hardware 300 (NIC functional unit), the client 100 offloads specific processing of an application to the accelerator 205 disposed in the server to perform computation. The NIC hardware 300 includes the accelerator function and argument data parsing unit 310 that deserializes packet data input from the client side according to a predetermined protocol format and obtains a function name and multiple arguments, the accelerator function and return value data packetization unit 330 that serializes the function name and arguments input from the accelerator according to a predetermined protocol format and packetizes the function name and arguments as a payload, the data transfer unit 320 that transfers the data deserialized by the accelerator function and argument data parsing unit to the server.

Thus, the computation offloading system 1000 includes the NIC hardware 300 on the server 200 side. The NIC hardware 300 is a dedicated one eliminating multiple protocol processing (L2, L3 protocol processing, packet pruning processing (NAPI), L4 protocol processing, ACC function parsing processing, and the like) required in the conventional technology by including the accelerator function and argument data parsing unit 310 having a single dedicated function. That is, as illustrated as an example in FIG. 7, the computation offloading system 1000 is represented such that during integration, the L2, L3, L4 protocols and its proprietary protocol are limited to specific protocols and implemented as dedicated circuits and the circuits are interconnected.

As a result, it is possible to eliminate the processing of selecting the L4/L3 protocol stack with multiple processes, and reduce latency by eliminating overhead in data linkage between the “protocol stack” of the OS and the “ACC function and argument data”. In the NIC hardware 300, in a stage before data is transferred to the server 200, it is possible to reduce overhead and increase the processing speed by reducing the number of times of selection and copy with the linkage of data

Since the NIC hardware 300 is implemented by hardware (HW), faster speed can be achieved.

In the computation offloading system 1000 (see FIGS. 1 and 2), the NIC hardware 300 is disposed on the server side, and the NIC hardware 300 transfers the data deserialized by the ACC function and argument data parsing unit 310 to the server 200.

As a result, on the server 200 side, it is possible to eliminate the processing of selecting the L4/L3 protocol stack with multiple processes, and reduce latency by eliminating overhead in data linkage between the “protocol stack” of the OS and the “ACC function and argument data”. In the NIC hardware 300, in a stage before data is transferred to the server 200, it is possible to reduce overhead and increase the processing speed by reducing the number of times of selection and copy with the linkage of data

In the computation offloading system 1000B (see FIG. 13), the NIC hardware 300B is disposed on the client side, and the NIC hardware 300B transfers the data deserialized by the ACC function and argument data parsing unit 310 to the client 100B.

As a result, on the client 100B side, it is possible to eliminate the processing of selecting the L4/L3 protocol stack with multiple processes, and reduce latency by eliminating overhead in data linkage between the “protocol stack” of the OS and the “ACC function and argument data”. In the NIC hardware 300, in a stage before data is transferred to the client 100B, it is possible to reduce overhead and increase the processing speed by reducing the number of times of selection and copy with the linkage of data

In the computation offloading system 1000A (see FIG. 13), the NIC hardware 300A (NIC functional unit) includes the ACC argument recording unit 201 that receives and records transfer target data to be transferred from the data transfer unit 320 to the server 100, the ACC function execution trigger recording unit 202 that records whether the arguments recorded in the ACC argument recording unit 201 are in a complete state (the ACC argument is executable) and whether the ACC function is executable, the ACC function execution trigger confirmation unit 203 that refers to the ACC function execution trigger recording unit 202 and detects that the offload function execution unit 204 can execute the ACC function based on the data recorded in the ACC argument recording unit 201, and the offload function execution unit 204 that executes an accelerator function based on input function name and arguments and links the result to the accelerator 205.

By doing so, accelerator offloading can be performed without using the CPU on the server 200A side, and the processing load on the server 200A can be reduced. In addition, since the NIC hardware 300A is configured by hardware (HW), faster speed can be achieved.

In the present embodiment, the packet processing inline inserting unit 121 (see FIGS. 1 and 2) is disposed in the client 100, but the packet processing inline inserting unit 121 may not be disposed. Although there is no synergistic effect with the present invention, there is an advantage that the system configuration can be simplified.

Further, all or some of the processes described as being performed automatically among the respective processes described in the embodiment and modifications can be performed manually, or all or some of the processes described as being performed manually can be performed automatically using a known method. Furthermore, information including processing procedures, control procedures, specific names, and various types of data and parameters set forth in the description and drawings given above can be arbitrarily changed unless otherwise specified.

In addition, the elements of the devices illustrated are conceptual functions and may not be necessarily configured as physically illustrated. That is, the specific form of distribution and integration of the respective devices is not limited to the illustrated form, and all or a part thereof can be configured to be functionally or physically distributed and integrated in any unit according to various loads, usage conditions, and the like.

Also, the above configurations, functions, processing units, processing means, and the like may be realized by hardware by designing a part or all of them with, for example, an integrated circuit, or the like. Further, the above-mentioned structures, functions, etc. may be realized by software for interpreting and executing programs for realizing the respective functions by the processor. Information such as a program, a table, a file for realizing each function is stored in a recording device such as a memory, a hard disk, an SSD (Solid State Drive), or a recording medium such as an IC (Integrated Circuit) card, an SD (Secure Digital) card, or an optical disk.

### REFERENCE SIGNS LIST

1 Network (NW)
100 Client
110, 110B Client HW
111 NIC
120, 120B OS
121 Packet processing inline inserting unit
122 NIC driver
130, 130B UserLAnd APL
131 User application unit
132 ACC function proxy reception unit
133 L3/L4 protocol and ACC function and argument data packet generation unit (ACC function and argument data packet generation unit)
134 L3/L4 protocol and ACC function and response data parsing unit (ACC function and response data parsing unit)
135 ACC function proxy response unit
200, 200A Server
210 Server HW
220 OS
230 UserLAnd APL
300 NIC hardware (NIC functional unit)
310 L3/L4 protocol and ACC function data parsing unit (ACC function data parsing unit)
320 Data transfer unit
330 L3/L4 protocol and ACC function and return value data packetization unit (ACC function and return value data packetization unit)
1000, 1000A, 1000B Computation offloading system

1. A computation offloading system comprising a client and a server connected to the client via a network and an NIC (Network Interface Card) functional unit, and wherein the client is configured to offload specific processing of an application to an accelerator disposed in the server to perform computation, wherein
the NIC functional unit includes:
an accelerator function and argument data parsing unit, comprising one or more processors, configured to deserialize packet data input from the client side according to a predetermined protocol format and obtain a function name and multiple arguments;
a data transfer unit, comprising one or more processors, configured to transfer the data deserialized by the accelerator function and argument data parsing unit to the server; and
an accelerator function and return value data packetization unit, comprising one or more processors, configured to serialize a function name and arguments input from the accelerator according to a predetermined protocol format and packetize the function name and arguments as a payload.

2. The computation offloading system according to claim 1, wherein
the NIC functional unit is disposed on the server side, and
the data transfer unit is configured to transfer the data deserialized by the accelerator function and argument data parsing unit to the server.

3. The computation offloading system according to claim 1, wherein
the NIC functional unit is disposed on the client side, and
the data transfer unit is configured to transfer the data deserialized by the accelerator function and argument data parsing unit to the client.

4. The computation offloading system according to claim 1, wherein the NIC functional unit includes:
an acceleration argument recording unit, comprising one or more processors, configured to receive and record transfer target data to be transferred from the data transfer unit to the server;
an acceleration function execution trigger recording unit, comprising one or more processors, configured to record whether the acceleration arguments and the acceleration function recorded in the acceleration argument recording unit are in an executable state;
an acceleration function execution trigger confirmation unit, comprising one or more processors, configured to refer to the acceleration function execution trigger recording unit and detect that an offload function execution unit is configured to execute the acceleration function based on the data recorded in the acceleration argument recording unit; and
the offload function execution unit, comprising one or more processors, configured to execute the accelerator function based on an input function name and arguments and link an execution result to the accelerator.

5. A computation offloading method in a computation offloading system comprising a client and a server connected to the client via a network and an NIC (Network Interface Card) functional unit, and wherein the client is configured to offload specific processing of an application to an accelerator disposed in the server to perform computation, wherein the NIC functional unit is configured to perform operations comprising:
deserializing packet data input from the client side according to a predetermined protocol format and obtaining a function name and multiple arguments;
transferring the deserialized data to the server, and
serializing a function name and arguments input from the accelerator according to a predetermined protocol format and packetizing the function name and arguments as a payload.
